(19) United States
(12) Patent Application Publication
(10) Pub. No.: US 2015/0355365 A1
(43) Pub. Date: Dec. 10, 2015

(54) Well-Logging Device with Dielectric Thermoset Material

(71) Applicant: SCHLUMBERGER TECHNOLOGY CORPORATION, Sugar Land, TX (US)

(72) Inventors: Clara Carelli, Paris (FR); Nathalie Lacroix, Paris (FR); Mohamed El Hadachy, Frenes (FR)

(21) Appl. No.: 14/655,706

(22) PCT Filed: Dec. 17, 2013
(86) PCT No.: PCT/US2013/075527

§ 371 Date: Jun. 25, 2015

(30) Foreign Application Priority Data
Dec. 28, 2012 (EP) 12306702.7

(51) Int. Cl. G01V 3/20; E21B 47/00

(52) U.S. Cl. CPC G01V 3/20; E21B 47/00

(57) ABSTRACT

A tool for geological formation having a borehole includes a housing to be positioned within the borehole and a device carried by the housing and including at least one electrical conductor in a dielectric thermoset material surrounding the at least one electrical conductor. The dielectric thermoset material is formed as a cyanate ester and molecular sieve blended therewith. The molecular sieve in one example is formed from zeolite and in another example is formed as a 5A molecular sieve and in yet another example a 13X molecular sieve.

### BACKGROUND

Well-logging instruments are used in wellbores to make, for example, formation evaluation measurements to infer properties of the formations surrounding the borehole and the fluids in the formations. Such well-logging instruments may include electromagnetic instruments, nuclear instruments, nuclear magnetic resonance (NMR) instruments, and caliper instruments, for example.

Well-logging instruments may be moved through a wellbore on an armored electrical cable (“wireline”) after the wellbore had been drilled. Such wireline tools are still used extensively. However, the desire for information while drilling the borehole gave rise to measurement-while-drilling (“MWD”) tools and logging-while-drilling (“LWD”) instruments, which are generally housed in special drill collars forming part of a string of drilling tools used to drill the wellbore. By collecting and processing such information during the drilling process, the wellbore operator can modify or adjust selected actions within the drilling operation to optimize wellbore performance and/or drilling performance.

MWD instruments may provide drilling parameter information such as axial force (weight) applied to a drill bit at the bottom of the drill string, torque applied to the drill string, wellbore temperature, wellbore fluid pressure, wellbore geodetic or geomagnetic direction, and wellbore inclination from vertical. LWD instruments may provide formation evaluation measurements such as formation electrical resistivity, porosity, and NMR relaxation time distributions. MWD and LWD instrument often have components similar in function to those provided in wireline tools (e.g., transmitting and receiving antennas), but MWD and LWD tools may be constructed to operate in the harsh environment of drilling. The terms MWD and LWD are often used interchangeably, and the use of either term in this disclosure will be understood to include both the collection of formation and wellbore information, as well as data on movement and placement of the drilling assembly.

The increase in operating temperatures and extreme mission profiles of various well-logging tools requires electronics that are reliable at high temperatures above 200° C. Different types of materials have been used in the electronic systems in well-boring tools, for example, adhesives, encapsulants, molding resins and insulating materials. Epoxy materials have been found to fail at temperatures as low as 150° C. Also, some electrical systems used in well-boring tools fail with time based on chemical failure due to chemical reactions within the material after high temperature exposure or mechanical failure due to cracks in material shrinkage observed in the surface and within the material. Some electrical failures are due to dielectric performance of the material at high temperatures that do not satisfy design specifications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A tool for geological formation having a borehole includes a housing to be positioned within the borehole and a device carried by the housing and including at least one electrical conductor and a dielectric thermoset material surrounding the at least one electrical conductor. The dielectric thermoset material is formed as a cyanate ester and molecular sieve blended therewith. The molecular sieve in one example is formed from zeolite and in another example is formed as a 5A molecular sieve. In yet another example, it is formed as a 13X molecular sieve.

In another example, the thermoset material is formed from cyanate ester in a weight percentage range of 90 to 100 percent and the thermoset material is formed with the molecular sieve at a weight percentage range of 0 to 10 percent. The dielectric thermoset material can include at least one filler in another example in a weight percentage range of 0 to 10 percent. In another example, electronic circuitry is coupled to the at least one electrical conductor and encapsulated by the dielectric thermoset material. The electronic circuitry is formed as sensor circuitry in another example and the at least one electrical conductor is formed as a plurality of connector pins. In yet another example, the device is carried by the housing so as to expose the dielectric thermoset material within a borehole.

### BRIEF DESCRIPTION OF THE DRAWINGS

FIG. 1 is a schematic diagram illustrating a well-logging system in accordance with an example embodiment.

FIG. 2 is a schematic diagram of a well-logging tool which may be used with the system of FIG. 1.

FIG. 3 is a schematic diagram of the device that is encapsulated by the dielectric thermoset material.

FIG. 4 is a schematic diagram showing the device encapsulated by the dielectric thermoset material.

FIG. 5 is an example connector having a device that is encapsulated by the dielectric thermoset material.

FIG. 6 is a schematic circuit diagram showing an electrical resistance measurement test set-up for the dielectric thermoset material in accordance with an example.

FIG. 7 is an image showing a dielectric thermoset material as a cyanate ester without a molecular sieve and showing the resulting popcorn effect.

FIG. 8 is a cross-sectional view of the image in FIG. 7 showing the popcorn effect.

FIG. 9 is an image showing the dielectric thermoset material formed as a cyanate ester and molecular sieve blended therewith in accordance with an example before aging and showing there is no popcorn effect.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

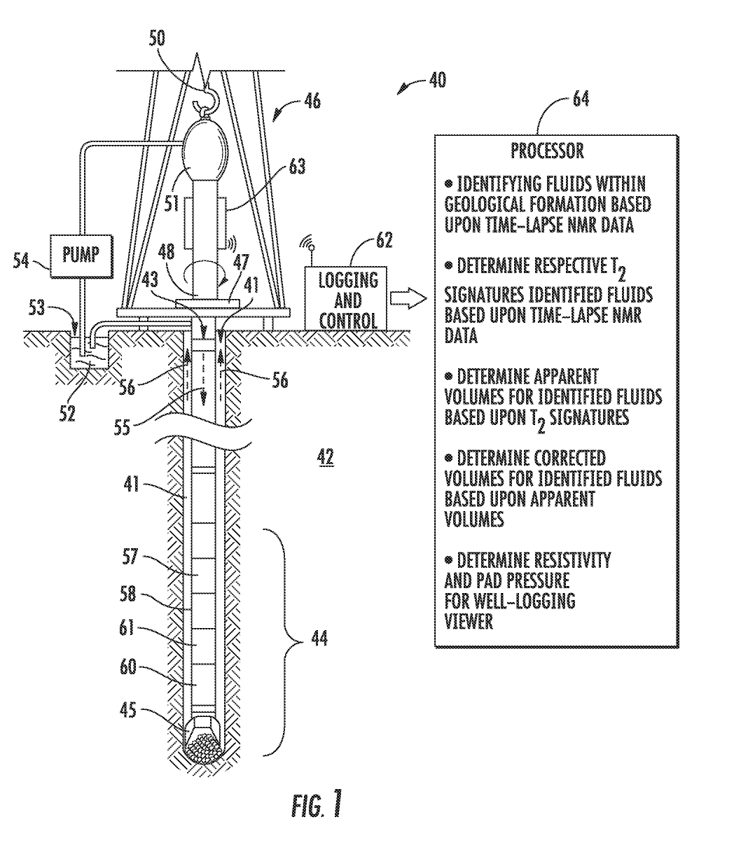

FIG. 1 illustrates a well site system 40 in which various embodiments may be implemented. In the illustrated example, the well site is a land-based site, but the techniques described herein may also be used with a water or offshore-based well site as well. In this example system, a borehole 41 is formed in a subsurface or geological formation 42 by rotary drilling, for example. Some embodiments may also use directional drilling, as will be described below.

A drill string 43 is suspended within the borehole 41 and has a bottom hole assembly (“BHA”) 44 which illustratively includes a drill bit 45 at its lower end. The system 40 further illustratively includes a platform and derrick assembly 46 positioned over the borehole 41. The assembly 46 illustratively includes a rotary table 47, kelly 48, hook 50 and rotary swivel 51. The drill string 43 may be rotated by the rotary table 47 which engages the kelly 48 at the upper end of the drill string. The drill string 43 is illustratively suspended from the hook 50, which is attached to a traveling block (not shown), through the kelly 48 and the rotary swivel 51 which permits rotation of the drill string relative to the hook. A top drive system (not shown) may also be used to rotate and axially move the drill string 43, for example.

In the present example, the system 40 may further include drilling fluid or mud 52 stored in a pit 53 formed at the well site (or a tank) for such purpose. A pump 54 delivers the drilling fluid 52 to the interior of the drill string 43 via a port in the swivel 51, causing the drilling fluid to flow downwardly through the drill string as indicated by the directional arrow 55. The drilling fluid exits the drill string 43 via ports or nozzles (not shown) in the drill bit 45, and then circulates upwardly through an annular space (“annulus”) between the outside of the drill string and the wall of the borehole, as indicated by the directional arrows 56. The drilling fluid lubricates the drill bit 45 and carries formation cuttings up to the surface as it is cleaned and returned to the pit 53 for recirculation.

The BHA 44 of the illustrated embodiment may include a logging-while-drilling (“LWD”) module 57, a measuring-while-drilling (“MWD”) module 58, a rotary steerable directional drilling system and motor 60, and the drill bit 45.

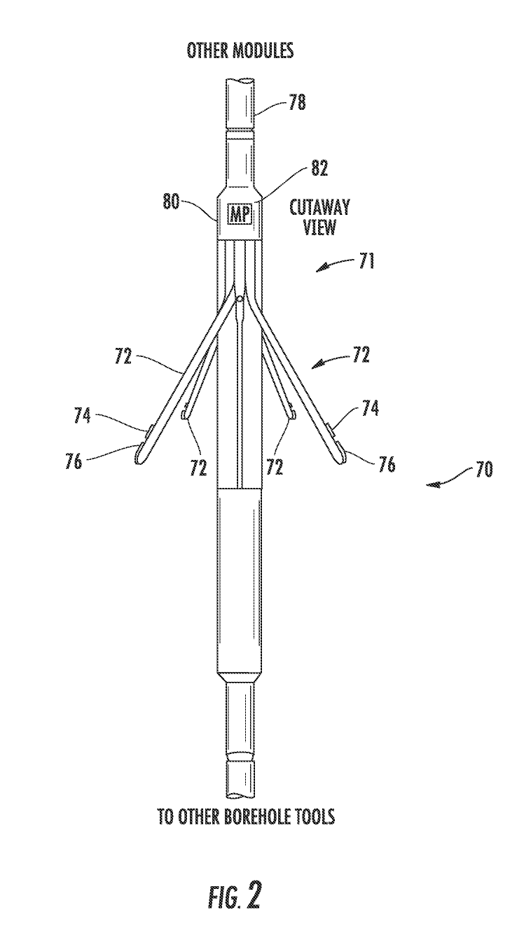

The LWD module 57 may be housed in a special type of drill collar, as is known in the art, and may include one or more types of well-logging instruments. It will also be understood that optional LWD and/or MWD modules 61 may also be used in some embodiments, such as a well-logging tool 70 for borehole measurement and injecting currents as shown at FIG. 2 and described below. (References, throughout, to a module at the position of 57 may mean a module at the position of 61 as well). The LWD module 57 may include capabilities for measuring, processing, and storing information, as well as for communicating the information with the surface equipment, e.g., to a logging and control unit 62, which may include a computer and/or other processors for decoding information transmitted from the MWD and LWD modules 57, 58 and recording and calculating parameters therefrom. Signals may be transmitted from a radio transmitter 63 to the logging and control unit 62. The information provided by the MWD and LWD modules 57, 58 may be provided to a processor 64 (which may be off site, or in some embodiments may be on-site as part of the logging and control unit 62, etc.) for determining volumetric information regarding constituents within the geological formation 42 and borehole measurements and resistivity as discussed further below.

FIG. 2 shows a well-logging tool 70 that is used with the well-logging system shown in FIG. 1 and positioned within the borehole. In this example, the well-logging tool 70 is formed as an Environmental Measurement Sonde (EMS) that determines the shape of the borehole over a wide range of borehole sizes and measures the borehole cross-section at different orientations to give detailed information on borehole geometry. These measurements result in a better environmental correction of imaging tool data and improved borehole stress analysis and estimation. This tool 70 includes an Environmental Measurement Mechanical (EMM) module 71 having four independent arms 72 that pivot or extend outward to make caliper measurements. Each arm supports an electrical current flow pad 74 that together form a plurality of electrical current flow pads for the tool 70 and press outwardly against adjacent portions of the borehole and establish respective current flow paths therethrough. Each arm 72 also supports a sensor 76 to form a plurality of sensors on the tool 70 to sense pressure and current flow for each of the plurality of electrical current flow pads 74.

The well-logging accomplished by this tool 70 may measure mud resistivity and mud temperature. It may also measure acceleration along the tool axis using an embedded accelerometer within the tool in another module. A single axial accelerometer may be used and data from that accelerometer is used to provide accurate depth matching of the borehole measurements, tool speed, and estimated hole deviation. Different modules may be supported within the tool, including a Digital Telemetry Cartridge (DTC), Environmental Measurement Sonde Adapter (EMA) and Environmental Measurement Cartridge (EMC) 78 shown above the EMM 71. Signals are transmitted back from the sensors 76 on the arms 72 upward along the tool and drill string to the logging and control unit 62. An algorithm based on the oval-radii measurements obtained from the tool 70 can give the best-fit ovality and provide borehole geometry with long- and short-axis diameters, their orientation and the tool arm positions.

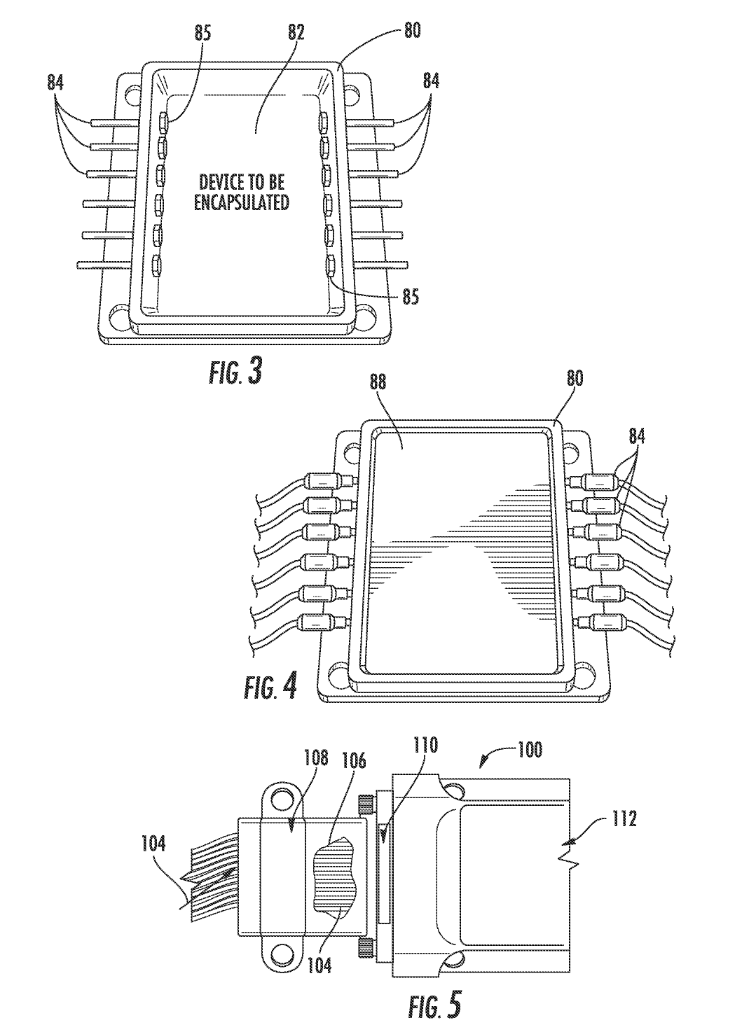

Part of the tool 70 is cut away above the arms to show a device carried by the housing 80 as part of the tool. In an example the device 82 is formed by at least one electrical conductor, and in the illustrated example, as electronic circuitry forming sensor circuitry. The device 82 is encapsulated by the dielectric thermoset material that is formed as a cyanate ester and a molecular sieve blended therewith and explained in greater detail below. The housing 80 may include a circuit package as shown in FIGS. 3 and 4 having the at least one electrical conductor and, in this example, the device 82 to be encapsulated as shown in FIG. 3. The device may be a microprocessor or other electronic circuit that is encapsulated by the dielectric thermoset material as shown in FIG. 4.

The electronics package as the housing 80 in FIGS. 3 and 4 includes a plurality of connector pins 84 that may connect to circuit traces 85 in the housing to interconnect with pads or leads on the device to be encapsulated. This housing as an electronics package in this illustrated example is contained within the tool as shown in FIG. 2 such that the dielectric thermoset material is exposed to the environment within the borehole. As a result, the dielectric thermoset material is formed to have a working temperature above 200° C. and around 215° C. in an example and have resistance to thermal cycles from −40° C. to 215° C. to withstand the harsh environmental conditions that occur in a borehole. It has resistance to hot shocks and an electrical insulation greater of R than 1G OHM under 500 volts. It has a loss of weight of less than 2% after 2,000 hours in high temperature and a suitable viscosity of about 5,000 to 12,000 CPS (MPS) at room temperature and a pot life of more than 6 hours.

FIG. 5 shows another example of a connector 100 in partial cutaway that may be used in accordance with an example that may include conductors carried by the connector and having at least one electrical conductor 104. The dielectric thermoset material 106 encapsulates as a molding a number of electrical conductors 104 as illustrated. The conductors as wires include splices inside the molding and a mechanical bridle 108 provides additional strength. The connector 100 includes a separate connector body 110 that connects to another electronic component 112 and forms a J4 connector assembly in this example.

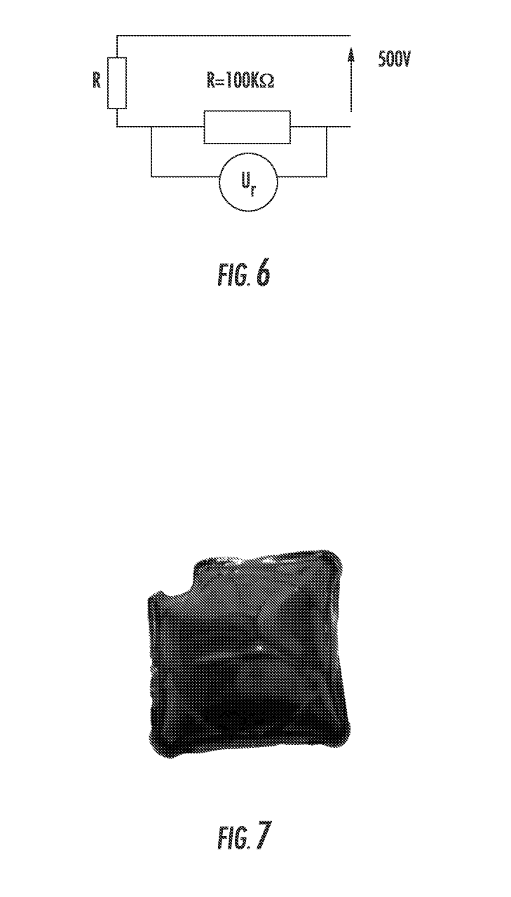

In the electronics package shown in FIGS. 3 and 4, the electrical resistance measuring is accomplished between two pins with monitoring under 500 volts DC as shown with the schematic circuit diagram in FIG. 6 in which R=500×100,000/U_{R}−100,000 in this example of a test for the design shown in FIGS. 3 and 4. The distance between pins in this example of FIGS. 3 and 4 is 2.3 MM instead of 1.27 MM for more conventional connectors of this type.

An example cyanate ester resin is PT30. An example molecular sieve is a zeolite material formed as a 5A molecular sieve or 13X molecular sieve. The cyanate ester as part of the thermoset material may be in a weight percentage range of 90 to 100 percent. The molecular sieve may be in a weight percentage range of 0 to 10 percent. The dielectric thermoset material includes at least one filler in an example that makes the dielectric thermoset material more manufacturable. The fillers do not alter the compatibility of the cyanate ester and molecular sieve blended therewith. In one example, the filler includes at least one filler in a weight percentage range of 0 to 10 percent in an example.

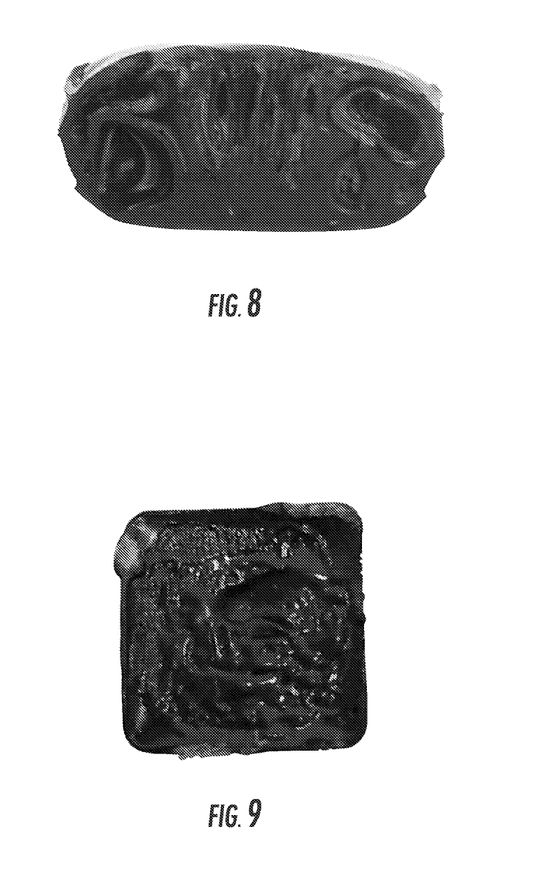

FIGS. 7 and 8 show an example of the cyanate ester resins that do not include a molecular sieve blended therewith These examples shown in FIGS. 7 and 8 are formed with a cyanate ester but do not include the molecular sieve blended therewith. Although cyanate ester resins are an important family of thermosetting resins and are desired for several reasons: thermal stability, low water absorption, low out-gassing and curing, high environmental resistance and excellent dielectric properties. These materials, however, are technically limited by the presence of moisture, in particular, during curing or by oxidation with time. This causes the resins to undergo the chemical reactions that release carbon dioxide and swelling occurs leading to resin deformation known as the “popcorn effect.” FIGS. 7 and 8 both show the “popcorn effect” when the cyanate ester resin is not blended with a molecular sieve. FIG. 7 shows a general image of the resin and FIG. 8 is a cross-section of the resin image of FIG. 7.

The presence of a molecular sieve in accordance with an example avoids the chemical degradations and resin swelling by trapping the moisture or carbon dioxide. An example such as described before has the molecular sieve formed as a zeolite such as a 5A or 13X (corresponding to 10A) molecular sieve. Other drying agents may be used for the reaction with CO2. Any fillers used with the dielectric allow increasing the resin viscosity at higher temperatures making them adequate for downhole tools and electrical connectors that require molding resins without standing long-term thermal stability and good dielectric properties.

In one example, zeolite is 4% by weight and mixed with the cyanate ester resin to form the dielectric thermoset material. In an example, the zeolite is regenerated at 125° C. for 12 hours and then mixed with the cyanate ester resin. Degassing occurs after the mixing followed by curing. In one example, the curing profile is one hour at 135° C. followed by two hours at 175° C. followed by two hours at 220° C. This forms in one example a curing profile that creates the dielectric thermoset material formed from the cyanate ester and molecular sieve blended therewith as a zeolite and it performs well in a downhole environment.

Because the polymerization is exothermic, the thickness of the cyanate ester should not be high and some molds and Teflon have been used for curing the samples. The cyanate ester with the molecular sieve forms the new resin with the -OCN structure that follows the polymerization reaction to form a cyclo-matrix having a high crosslink density network structure and excellent dielectric properties, high thermal resistance, a low thermal expansion coefficient (CTE) and good chemical properties. A filler adds to the manufacturability. The cure reaction is a trimerization of three CN groups to a triazine ring. In an example, the resulting structure is a 3D polymer network because the starting material is in two cyanate groups.

Although zeolite as a molecular sieve material used in accordance with one example as described, other molecular sieve materials can be used as porous crystalline metal-alumino silicates that have a uniformity in pore size in a crystal-lattice structure. Molecular sieves are classified by their pore size in Angstroms such as 3A, 4A, 5A, 8A (10X) and 10A also known as 13X. The 5A molecular sieve in one example adsorbs from linear (normal) hydrocarbons to N-C4H10, alcohols to C4H9OH and mercaptans to C4H9SH. The A10 as 13X adsorbs di-n-butylamine and hexamethylphosphoramides as HMPA. Some molecular sieves may be used that adsorb up to 22% of their weight and hold moisture to temperatures past 230° C. for use in downhole environments. 5A molecular sieves are useful with desiccation and purification of air and dehydration and desulphurization of natural gas and desulphurization of petroleum gas and oxygen and hydrogen production by pressure swing absorption processes. A 13X molecular sieve as a 10A size is useful in desiccation, desulphurization and purification of petroleum gas and natural gas.

In one example as described before, the zeolite is used as the molecular sieve blended with the cyanate ester. The zeolites are microporous, aluminosilicate mineral and accommodate a variety of cations. It is also possible to use other materials that act as a CO2 scavenger, for example, MgO.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A tool (70) for a geological formation having a borehole (41) therein, the tool comprising:
a housing (80) to be positioned within the borehole; and
a device (82) carried by said housing and characterized by at least one electrical conductor (104) and a dielectric thermoset material (106) surrounding said at least one electrical conductor;
said dielectric thermoset material comprising a cyanate ester and a molecular sieve blended therewith.

2. The tool according to claim 1 wherein said molecular sieve comprises zeolite.

3. The tool according to claim 1 wherein said dielectric thermoset material (106) comprises said cyanate ester in a weight percentage range of 90 to 100 percent.

4. The tool according to claim 1 wherein said dielectric thermoset material (106) comprises said molecular sieve in a weight percentage range of 0 to 10 percent.

5. The tool according to claim 1 wherein said dielectric thermoset material (106) comprises at least one filler.

6. The tool according to claim 1 wherein said device (82) further comprises electronic circuitry coupled to said at least one electrical conductor and encapsulated by said dielectric thermoset material (106).

7. The tool according to claim 9 wherein said electronic circuitry comprises sensor circuitry.

8. The tool according to claim 1 wherein said at least one electrical conductor (104) comprises a plurality of connector pins.

9. A method for making a tool (70) for a geological formation having a borehole (41) therein, the method comprising:
forming a device (92) characterized by at least one electrical conductor (104) and a dielectric thermoset material (106) surrounding the at least one electrical conductor, the dielectric thermoset material comprising a cyanate ester and a molecular sieve blended therewith; and
coupling the device to a housing (80) to be positioned within the borehole.

10. The method according to claim 9 wherein the molecular sieve comprises zeolite.

11. The method according to claim 9 wherein the dielectric thermoset material (106) comprises the cyanate ester in a weight percentage range of 90 to 100 percent, and wherein the dielectric thermoset material comprises the molecular sieve in a weight percentage range of 0 to 10 percent.

12. The method according to claim 9 wherein the dielectric thermoset material (106) comprises at least one filler in a weight percentage range of 0 to 10 percent.

13. The method according to claim 9 wherein the device further comprises electronic circuitry coupled to the at least one electrical conductor (104) and encapsulated by the dielectric thermoset material.

14. The method according to claim 9 wherein the at least one electrical conductor (104) comprises a plurality of connector pins.

15. The method according to claim 9 wherein coupling the device to the housing (80) comprises coupling the device to the housing so as to expose the dielectric thermoset material within the borehole.
